(19) United States
(12) Patent Application Publication
(10) Pub. No.: US 2009/0118117 A1
(43) Pub. Date: May 7, 2009

(54) SOLVENT, ADDITIVE AND CO-CATALYST EFFECTS FOR ETHYLENE OLIGOMERIZATION CATALYSIS

(76) Inventors: Paul R. Elowe, Midland, MI (US); John E. Bercaw, Pasadena, CA (US)

Correspondence Address: CHRISTIE, PARKER & HALE, LLP, PO BOX 7068, PASADENA, CA, 91109-7068, US

(21) Appl. No.: 12/243,904

(22) Filed: Oct. 1, 2008

Related U.S. Application Data
(60) Provisional application No. 60/997,139, filed on Oct. 1, 2007.

(51) Int. Cl. C08F 4/52

(52) U.S. Cl. 502/102

(57) ABSTRACT

The invention is directed to catalyst systems for the oligomerization of ethylene. In some embodiments, the catalyst system includes ethylene, a solvent, and a catalyst activated with an aluminoxane co-catalyst. The system may further include an additive. Various modifications to the different reaction parameters may be made to fine-tune the reaction properties, such as productivity, activity and selectivity for a particular oligomer. For example, the solvent may be modified to include a mixture of at least two solvents. Alternatively, the co-catalyst may be modified by aging or partially fluorinating the co-catalyst. In another alternative, an additive may be included in the reaction system. Each modification to the reaction system effects a different reaction outcome, thereby enabling fine-tuning of the reaction properties by varying the modifications to the reaction system.

### CROSS-REFERENCE TO RELATED APPLICATION(S)

This application claims priority to and the benefit of U.S. Provisional Application Ser. No. 60/997,139, titled “SOLVENT AND ADDITIVE EFFECTS FOR ETHYLENE OLIGOMERIZATION CATALYSIS,” filed on Oct. 1, 2007, the entire content of which is incorporated herein by reference.

### STATEMENT REGARDING FEDERALLY SPONSORED RESEARCH OR DEVELOPMENT

The U.S. Government has certain rights in this invention pursuant to Grant No. DE-FG02-85ER13431 awarded by the Department of Energy.

### FIELD OF THE INVENTION

The invention is directed to solvent, additive, and co-catalyst effects for ethylene oligomerization catalysis. More particularly, the invention is directed to improved processes for the selective production of the α-olefins, 1-hexene and 1-octene.

### BACKGROUND OF THE INVENTION

Linear low-density polyethylene is used in a wide variety of applications, and demand for the polymer is ever increasing. Producing linear low-density polyethylene generally involves the polymerization of ethylene with an α-olefin, such as 1-hexene or 1-octene. These α-olefins can be produced in a number of ways, one of which is the oligomerization of ethylene. This oligomerization has been accomplished through catalytic systems, the development of which has been the subject of much research due to the commercial desirability of α-olefins.

While selective ethylene trimerization systems, predominantly chromium-based, have been known for some time, selective tetramerization systems are less known. However, one such system involves a reaction catalyzed by an aluminoxane-activated chromium species bearing a PNP diphospine ligand. However, the selectivity of 1-octene over 1-hexene, though improved in this system, remains lower than desired.

### SUMMARY OF THE INVENTION

Systems designed to select 1-octene over 1-hexene generally include ethylene, a chromium-based catalyst activated with an aluminoxane co-catalyst, and a solvent. According to embodiments of the present invention, modifications to the co-catalyst and/or solvent significantly and surprisingly enhance the selectivity of 1-octene over 1-hexene. In particular, the reaction solvent affects the outcome of the oligomerization, both in terms of activity and selectivity between trimers, tetramers, higher oligomers, and polymers. Polar solvents such as chlorobenzene, 1,2-dichlorobenzene, fluorobenzene and 1,2-difluorobenzene produce reactions that are more active, stable, and selective for oligomers than nonpolar solvents such as toluene and dodecane. However, such halogenated solvents are expensive and each solvent tends to favor production of one oligomer over the others, making fine-tuning of selectivity difficult.

Pressure also affects selectivity and activity of the oligomerization reaction. Specifically, reactions at higher pressures of ethylene result in both higher overall activity and enhanced production of 1-octene over 1-hexene. Indeed, there is a linear relationship between the ratio of 1-octene to 1-hexene and the concentration of ethylene. Although the selectivity between the trimer and tetramer can be adjusted with reaction pressure, there is a practical pressure limit for any reaction, thus limiting the application of this technique for commercial purposes.

Short reaction times may reduce the production of undesirable polyethylene as well as higher oligomers. Short reaction times also place heavy constraints on reaction system design, limiting the application of such a technique for fine-tuning the selectivity of the reaction.

Embodiments of the present invention are directed to catalyst systems for the oligomerization of ethylene. In some embodiments, the system includes ethylene, a catalyst, a co-catalyst and a mixture of at least two solvents. The catalyst is a chromium-based precatalyst and is activated in an aluminoxane co-catalyst. The aluminoxane may be a methylaluminoxane, aged methylaluminoxane, or partially halogenated methylaluminoxane (such as partially fluorinated methylaluminoxane).

The system may further comprise an additive. The additive serves to increase 1-octene/1-hexene selectivity, and does not substantially affect overall productivity of the oligomerization reaction. Nonlimiting examples of suitable coordinating additives include anisole and N,N-dimethylaniline.

In other embodiments, the catalyst system includes ethylene, a catalyst, a co-catalyst, and a solvent. Here, the solvent may be a single solvent or a mixture of at least two solvents. The co-catalyst is selected from aged methylaluminoxane and partially fluorinated methylaluminoxane. The catalyst is a chromium-based catalyst activated with the co-catalyst. The catalyst system may further include an additive such as anisole or N,N-dimethylaniline.

In still other embodiments, the catalyst system includes ethylene, a catalyst, a co-catalyst, a solvent and an additive. Here, the solvent may be a single solvent or a mixture of at least two solvents. The co-catalyst may be an aluminoxane such as methylaluminoxane, aged methylaluminoxane or partially fluorinated methylaluminoxane.

### DETAILED DESCRIPTION OF THE INVENTION

The present invention is directed to catalyst systems for the oligomerization of ethylene in which modifications to the solvent and co-catalyst, and additions of additives have surprising and beneficial effects on the selectivity, activity and productivity of the ethylene oligomerization reactions. Modifications to the oligomerization reaction medium can drastically enhance the ability to fine-tune the activity and selectivity of the oligomerization. Such modifications can be made in the choice of solvent, the addition of additives, the modification of co-catalysts, and changes in temperature and/or pressure. These modifications affect the oligomerization reaction differently, most enhancing either activity, selectivity or productivity, and some improving all three. For example, temperature increases result in lower productivity and higher production of polyethylene, but do not significantly affect the selectivity between oligomers. According to some embodiments, mixtures of polar and nonpolar solvents enable retention of high selectivity and productivity and reductions in production costs. In still other embodiments, coordinating additives may enhance 1-octene production over 1-hexene. In yet other embodiments, modifications in the co-catalyst improve productivity, but do not substantially affect selectivity between 1-octene and 1-hexene.

Embodiments of the present invention provide ethylene oligomerization systems that enable fine-tuning of the reaction to enhance one or all of productivity, activity and selectivity to a particular oligomer. This fine-tuning of the reaction is accomplished by employing at least one modification in the reaction medium, and in some embodiments, the fine-tuning involves modifying at least two reaction parameters.

### Modifications of the Solvent

Solvents with high dielectric constants, notably chlorobenzenes and fluorobenzenes, exhibit high activity for trimerization and tetramerization, and generate very little undesired polyethylene compared with traditional nonpolar solvents, such as toluene. However, these halogenated solvents are expensive, giving rise to a demand for less expensive solvents exhibiting the same or better activity for trimerization and tetramerization. Accordingly, in some embodiments of the present invention, mixtures of polar and nonpolar solvents enable retention of high selectivity and productivity and reductions in production costs.

In some embodiments of the present invention, a catalyst system for ethylene oligomerization includes ethylene, a precatalyst activated in a co-catalyst and a mixture of at least two solvents. The mixture of solvents significantly improves the selectivity of the oligomerization reaction and this modification of the reaction solvent is one tool for fine-tuning the properties of the oligomerization reaction.

The ethylene may be any suitable ethylene gas pressurized at any suitable pressure. For example, in some embodiments, the ethylene is pressurized up to 100 atm. In some embodiments, the ethylene is pressurized to 1 atm, and in other embodiments, the ethylene is pressurized to 4 atm.

The precatalyst may be any suitable precatalyst for ethylene oligomerization. Nonlimiting examples of suitable precatalysts include those represented by Formula 1, below.

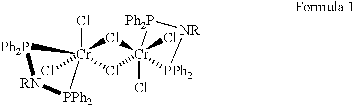

In Formula 1, R can be any hydrocarbon substituent, and the hydrocarbon substituents may be either substituted or unsubstituted. Nonlimiting examples of suitable hydrocarbon substituents include substituted and unsubstituted alkyl groups, substituted and unsubstituted alkenyl groups, substituted and unsubstituted alkynyl groups, substituted and unsubstituted aryl groups, substituted and unsubstituted heteroaryl groups, and the like. In one embodiment for example, R is either an isopropyl group or a 2-methoxy benzyl group. For example, R may be selected from (CH₂)₂OCH₃, (CH₂)₃OCH₃, (o-OCH₃)C₆H₄, CH₂(o-OCH₃)C₆H₄, and CH₂(CH₃)₂. In one embodiment, for example, R is selected from CH₂(o-OCH₃)C₆H₄, and CH₂(CH₃)₂. The hydrocarbon substituents may be substituted with any suitable coordinating group, heteroatomic functionality, etc. For example, the R group may be substituted with F, Cl, Br, I, NR′₂, PR′₂, OR′₂, SR′₂, BR′₂, AIR′₂, etc., where R′ may be any alkyl group, alkenyl group, alkynyl group, aryl group, etc. Nonlimiting examples of suitable precatalysts satisfying Formula 1 include (C₆H₅)₂PN(CH₂CH₂OCH₃)P(C₆H₅)₂, (C₆H₅)₂PN(CH₂CH₂CH₂OCH₃)P(C₆H₅)₂, (C₆H₅)₂PN((o-OCH₃)C₆H₄)P(C₆H₅)₂, (C₆H₅)₂PN(CH₂(o-OCH₃)C₆H₄)P(C₆H₅)₂, (C₆H₅)₂PN(CH(CH₃)₂)P(C₆H₅)₂, (C₆H₅)₂PN(CH₂(o-CH₂CH₃)C₆H₄)P(C₆H₅)₂, [CrCl₂((C₆H₅)₂PN(CH₂CH₂OCH₃)P(C₆H₅)₂)(μ-Cl)]₂, [CrCl₂((C₆H₅)₂PN(CH₂CH₂CH₂OCH₃)P(C₆H₅)₂)(μ-Cl)]₂, [CrCl₂((C₆H₅)₂PN((o-OCH₃)C₆H₄)P(C₆H₅)₂)(μ-Cl)]₂, [CrCl₂((C₆H₅)₂PN(CH₂(o-OCH₃)C₆H₄)P(C₆H₅)₂)(μ-Cl)]₂, [CrCl₂((C₆H₅)₂PN(CH(CH₃)₂)P(C₆H₅)₂)(μ-Cl)]₂, and [CrCl₂((C₆H₅)₂PN(CH₂(o-CH₂CH₃)C₆H₄)P(C₆H₅)₂)(μ-Cl)]₂.

The co-catalyst may be any suitable co-catalyst for activating the precatalyst. Nonlimiting examples of suitable co-catalysts include aluminoxanes. In some embodiments, for example, the co-catalyst may be methylaluminoxane (represented by Formula 2, below), aged methylaluminoxane or partially fluorinated methylaluminoxane (represented by Formula 3, below).

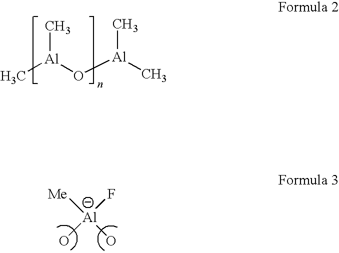

The reaction solvent includes a mixture of at least two solvents. In one embodiment, for example, the solvent includes at least one polar solvent and at least one nonpolar solvent. Nonlimiting examples of suitable solvents include chlorobenzene, toluene, dodecane, benzene, 1,2-dichlorobenzene, fluorobenzene, 1,2-difluorobenzene, and the like.

As the modification to the reaction solvent is a tool for fine-tuning the properties of the oligomerization reaction, the choice and relative amounts of the solvents in the mixture are selected to enhance the desired properties, i.e., productivity, activity and/or selectivity. In one embodiment, the solvent includes a mixture of at least one polar solvent and at least one nonpolar solvent in a ratio ranging from about 0.01:1 to about 1:0.01. In one exemplary embodiment, the ratio may be 1:1. For example, selectivity for 1-octene may be increased by selecting a mixed solvent of chlorobenzene and toluene. Although the overall productivity in a 1:1 mixture of these solvents is lower than in chlorobenzene alone, the reaction produces a higher fraction of 1-octene and a lower fraction of higher oligomers. In another embodiment, a 1:1 mixture of 1,2-difluorobenzene and dodecane results in increased overall activity and decreased production of polyethylene compared with either solvent alone.

### Modification of the Co-Catalyst

In other embodiments of the present invention, a catalyst system for ethylene oligomerization includes ethylene, a precatalyst activated with a co-catalyst and a solvent. Here, modifications to the co-catalyst improve productivity, but do not substantially affect selectivity between 1-octene and 1-hexene. As noted above with respect to the solvent modifications, the co-catalyst is used to activate the precatalyst. For example, a precatalyst (represented by Formula 1) is activated by a methylaluminoxane (MAO) co-catalyst (represented by Formula 2) in a solvent under ethylene. The MAO co-catalyst includes a 10 wt % solution of MAO in toluene, and the MAO co-catalyst may be modified to influence activity without substantially affecting 1-hexene/1-octene selectivity. For example, in some embodiments, the MAO co-catalyst is a 10 wt % solution of MAO in toluene. Although MAO is described as a 10 wt % solution, it is understood that any concentration of MAO may be used. Also, although toluene is described as the solvent, any suitable solvent may be used. In other embodiments, the MAO co-catalyst is a 10 wt % solution of MAO in toluene, in which the MAO has been aged. The MAO may be aged for any length of time, for example from about 3 weeks or longer. This aged MAO co-catalyst is denoted MAO* throughout the specification and claims. In still other embodiments, the MAO co-catalyst is a 10 wt % solution of partially fluorinated MAO (represented by Formula 3) in toluene. This partially fluorinated MAO co-catalyst is denoted F-MAO throughout the specification and claims.

Modification of the co-catalyst effects an increase in the overall productivity of the reaction. Also, the choice of the aluminoxane co-catalyst can have a significant effect on the extent of the increase. For example, a 10 wt % solution of F-MAO in toluene increased the productivity by about 20 to about 50% without significantly affecting the selectivity of the oligomerization reaction.

Here, the solvent need not be a mixture of two solvents, but rather can be any suitable solvent for ethylene oligomerization. However, since solvent modifications and co-catalyst modifications are both tools for fine-tuning the properties of the oligomerization reaction, both the co-catalyst and the solvent may be modified to produce the desired reaction properties. Accordingly, in some embodiments, the co-catalyst may be selected from MAO* and F-MAO and the solvent may include a mixture of at least two solvents. In other embodiments, though, when the co-catalyst is selected from MAO* and F-MAO, the solvent need not be modified and may be a single solvent depending on the desired oligomerization reaction properties.

### Addition of an Additive

In still other embodiments, a catalyst system for ethylene oligomerization includes ethylene, a precatalyst activated with a co-catalyst, a solvent, and an additive. In these embodiments, any suitable solvent or mixture of solvents may be used. For example, the solvent may include benzene, chlorobenzene, fluorobenzene, and combinations thereof. The addition of coordinating additives in the catalyst system enhances 1-octene production over 1-hexene.

Any suitable coordinating additive may be used, nonlimiting examples of which include anisole and N,N-dimethylaniline (represented by Formula 4 below). Although anisole and N,N-dimethylaniline are suitable additives, it is understood that any suitable coordinating additive may be used. For example, any compound containing at least one heteroatom (O, N, S, P, etc.) may be used as the coordinating additive. The addition of a coordinating additive increases the ratio of 1-octene/1-hexene without substantially affecting overall productivity. The additive may be present in any suitable amount. In some embodiments, for example, the additive is present in an amount ranging from about 1 to 200 equivalents. In one embodiment, for example, the additive is present in an amount of about 20 equivalents. In one exemplary embodiment, the additive is N,N-dimethylaniline, and is added in an amount of 20 equivalents to a reaction in benzene. This reaction (i.e., 20 equivalents N,N-dimethylaniline in benzene) results in a slight increase in the 1-octene/1-hexene ratio and a negligible effect on productivity. In another embodiment, the additive is methoxybenzene, and this reaction also increases the 1-octene/1-hexene ratio with only a slight decrease in overall productivity.

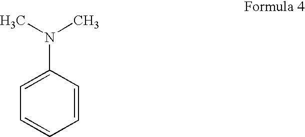

In catalyst systems including an additive, the solvent need not be a mixture of two solvents, but rather can be any suitable solvent for ethylene oligomerization. However, since solvent modifications and additive additions are both tools for fine-tuning the properties of the oligomerization reaction, the solvent may be modified and an additive included to produce the desired reaction properties. Accordingly, in some embodiments, the catalyst system includes an additive, and the solvent may include a mixture of at least two solvents. In other embodiments, though, when the additive is included, the solvent need not be modified and may be a single solvent depending on the desired oligomerization reaction properties.

According to embodiments of the present invention, any combination of modifications to the oligomerization reaction system may be used depending on the desired reaction properties. For example, in one embodiment, the catalyst system may include a modified solvent including a mixture of at least two solvents, ethylene, and a precatalyst activated with an aluminoxane co-catalyst. In another embodiment, the catalyst system may include a single solvent, ethylene, and a precatalyst activated with a modified aluminoxane co-catalyst. In still another embodiment, the catalyst system may include a single solvent, ethylene, a precatalyst activated with an aluminoxane co-catalyst, and an additive. In addition to these singular modifications, in some embodiments of the present invention, two or more modifications are made in a single catalyst system. For example, in one embodiment, a catalyst system may include a modified solvent including a mixture of at least two solvents, a pre-catalyst activated with a modified aluminoxane catalyst, and ethylene. Alternatively, a catalyst system may include a single solvent, ethylene, a precatalyst activated with a modified aluminoxane co-catalyst, and an additive. In yet another alternative, a catalyst system may include ethylene, a modified solvent including a mixture of at least two solvents, a precatalyst activated with a co-catalyst, and an additive. In still another alternative, a catalyst system may include all three modifications, i.e., the system may include ethylene, a modified solvent including a mixture of at least two solvents, a precatalyst activated with a modified aluminoxane co-catalyst, and an additive.

### EXAMPLES

The following Examples are presented for illustrative purposes only and are not to be construed as limiting the scope of the present invention. In the Examples, all air- and moisture-sensitive compounds were manipulated using standard vacuum line, Schlenk, or cannula techniques or in a glovebox under a nitrogen atmosphere. All gases were purified by passage over MnO on vermiculite and activated molecular sieves. Solvents for air- and moisture-sensitive reactions were dried over sodium benzophenone ketyl, calcium hydride, or by the method described in Pangborn et al., “Safe and Convenient Procedure for Solvent Purification,” Organometallics, vol. 15, pg. 1518 (1996), the entire content of which is incorporated herein by reference. MAO (10 wt % in toluene), and (THF)₃CrCl₃ were obtained from Aldrich. F-MAO (10 wt % in toluene) was obtained from Albemarle.

Precatalysts were synthesized following the procedures described in Elowe, et al., “Nitrogen-Linked Diphosphine Ligands with Ethers Attached to Nitrogen for Chromium-Catalyzed Ethylene Tri- and Tetramerizations,” Organometallics, vol. 25, pg. 5255-5260 (2006), the entire content of which is incorporated herein by reference. Specifically, (C₆H₅)₂PN(CH₂CH₂OCH₃)P(C₆H₅)₂ was prepared by the following process. Chlorodiphenylphosphine (4.5 mL, 24 nmol, 2.3 equiv.) was dissolved in dry toluene (150 mL). Under an atmosphere of argon, an excess of triethylamine (5.0 mL, 36 mmol) was syringed into the reaction flask, which was stirred for 5 minutes. 2-Methoxyethylamine (0.9 mL, 10 mmol) was then syringed dropwise under argon. A precipitate immediately formed. The reaction mixture was then allowed to stir for 36 hrs at 110° C. The ammonium salt was filtered off and the solvent and the excess triethylamine and chlorodiphenylphosphine were removed in vacuo to leave a yellow residue. The residue was passed through a silica gel plug using a CH₂Cl₂ (15%)/petroleum ether (85%) mixture as the eluent. Removing the solvent afforded 2.905 g of a fine white powder in 63% yield. ¹H NMR (RT, 300 MHz, CDCl₃): δ=2.90 (2H, t, J_{HH}=7.4 Hz, CH₂O), 3.02 (3H, s, OCH₃), 3.47 (2H, m, CH₂), 7.29-7.44 (20H, m, ArH). ³¹P NMR (RT, 121 MHz, CDCl₃): δ=64.6 ppm (s). MS (FAB+): 444 (M+H).

Also, (C₆H₅)₂PN(CH₂CH₂CH₂OCH₃)P(C₆H₅)₂ was prepared by the following process. Chlorodiphenylphosphine (4.9 mL, 26 mmol, 2.5 equiv.) was dissolved in dry toluene (150 mL). Under an atmosphere of argon, an excess of triethylamine (8.0 mL, 58 mmol) was syringed into the reaction flask, which was stirred for 5 minutes. 3-Methoxypropylamine (1.1 mL, 11 mmol) was then syringed dropwise under argon. A precipitate immediately formed. The reaction mixture was then allowed to stir for 36 hrs at 110° C. The ammonium salt was filtered off and the solvent and the excess triethylamine and chlorodiphenylphosphine were removed in vacuo to leave a yellowish residue. The residue was passed through a silica gel plug using a CH₂Cl₂/petroleum ether (1:1) mixture as the eluent. Removing the solvent and trituration with petroleum ether afforded 3.564 g of a fine white powder in 75% yield. ¹H NMR (RT, 300 MHz, CDCl₃): δ=1.39 (2H, br tt, J_{HH}=8.1 Hz, J_{HH}=6.3 Hz, CH₂), 3.03 (2H, t, J_{HH}=6.3 Hz, CH₂O), 3.10 (3H, s, OCH₃), 3.27-3.44 (2H, m, NCH₂), 7.28-7.46 (20H, m, ArH). ³¹P NMR (RT, 121 MHz, CDCl₃): δ=63.1 ppm (s). MS (FAB+): 458 (M+H).

In addition, (C₆H₅)₂PN((o-OCH₃)C₆H₄)P(C₆H₅)₂ was prepared by the following process. Chlorodiphenylphosphine (5.8 mL, 31 mmol, 2.3 equiv.) was dissolved in dry THF (150 mL). Under an atmosphere of argon, an excess of triethylamine (9.0 mL, 65 mmol) was syringed into the reaction flask, which was stirred for 5 minutes. o-Anisidine (1.5 mL, 14 mmol) was then syringed dropwise under argon. A precipitate immediately formed and the mixture turned deep yellow. The reaction mixture was then allowed to stir for 24 hrs at 62° C. The reaction can only afford about 75% conversion (longer reaction times do not increase conversion). The solvent and the excess trimethylamine and chlorodiphenylphosphine were removed in vacuo. The yellow residue was dissolved in CH₂Cl₂ and washed with 10% NaOH. The organic fraction was dried over MgSO₄ and the solvent removed after filtration, which afforded a yellow oil. After dissolving the oil in a minimum amount of CH₂Cl₂, petroleum ether was added and a white powder crashed out at room temperature to give 4.642 g of the desired compound in 70% yield. ¹H NMR (RT, 300 MHz, CDCl₃): δ=3.29 (3H, s, OCH₃), 6.79-6.71 (1H, m, ArH), 7.01-7.11 (1H, m, ArH), 7.16-7.51 (20H, m, ArH), 7.55-7.65 (1H, m, ArH), 7.73-7.83 (1H, m, ArH). ³¹P NMR (RT, 121 MHz, CDCl₃): δ=65.5 ppm (s). MS (FAB+): 491 (M+H).

(C₆H₅)₂PN(CH₂(o-OCH₃)C₆H₄)P(C₆H₅)₂ was prepared by the following process. Chlorodiphenylphosphine (4.6 mL, 24.7 mmol, 2.5 equiv.) was dissolved in dry CH₂Cl₂ (150 mL). Under an atmosphere of argon, an excess of triethylamine (7.0 mL, 50.6 mmol) was syringed into the reaction flask, which was stirred for 5 minutes. 2-methoxybenzylamine (1.3 mL, 9.9 mmol) was then syringed dropwise under argon. A precipitate immediately formed and the mixture turned deep yellow. The reaction mixture was then allowed to stir for 14 hrs at 37° C. The solvent and the excess trimethylamine and chlorodiphenylphosphine were removed in vacuo. The yellow residue was dissolved in CH₂Cl₂ and washed with 10% NaOH. The organic fraction was dried over MgSO₄ and the solvent removed after filtration, which afforded an off-white solid. After dissolving the solid in a minimum amount of CH₂Cl₂, acetonitrile was added and a white powder crashed out at room temperature to give 3.366 g of the desired compound in 67% yield. ¹H NMR (RT, 300 MHz, CDCl₃): δ=3.70 (3H, s, OCH₃), 4.47 (2H, t, J_{HP}=9.2 Hz, CH₂), 6.66-6.84 (3H, m, NCH₂ArH), 7.09-7.18 (1H, m, NCH₂ArH), 7.22-7.32 (12H, m, ArH), 7.35-7.44 (8H, m, ArH). ³¹P NMR (RT, 121 MHz, CDCl₃): δ=59.9 ppm (s). MS (Direct Insertion Probe EI): 505.17.

(C₆H₅)₂PN(CH(CH₃)₂)P(C₆H₅)₂ was prepared by the following process. Chlorodiphenylphosphine (4.0 mL, 21.5 mmol, 2.3 equiv.) was dissolved in dry CH₂Cl₂ (150 mL). Under an atmosphere of argon, an excess of triethylamine (5.5 mL, 39.8 mmol) was syringed into the reaction flask, which was stirred for 5 minutes. isopropylamine (0.8 mL, 9.4 mmol) was then syringed dropwise under argon. The reaction mixture was then allowed to stir for 14 hrs at room temperature. The solvent and the excess trimethylamine and chlorodiphenylphosphine were removed in vacuo. The yellow residue was dissolved in Et₂O and washed with 1M NaOH. The organic fraction was dried over MgSO₄ and the solvent removed after filtration, which afforded an off-white oil. After dissolving the oil in a minimum amount of CH₂Cl₂, acetonitrile was added and a white powder crashed out at room temperature to give 2.823 g of the desired compound in 71% yield. ¹H NMR (RT, 300 MHz, CDCl₃): δ=1.15 (6H, d, J_{HH}=6.5 Hz, CH(CH₃)₂), 3.76 (1H, m, CHMe₂), 7.25-7.41 (20H, m, ArH). ³¹P NMR (RT, 121 MHz, CDCl₃): δ=49.5 ppm (s).

(C₆H₅)₂PN(CH₂(o-CH₂CH₃)C₆H₄)P(C₆H₅)₂ was prepared by the following process. Chlorodiphenylphosphine (1.9 mL, 10.1 mmol, 2.3 equiv.) was dissolved in dry CH₂Cl₂ (80 mL). Under an atmosphere of argon, an excess of triethylamine (3.5 mL, 25.3 mmol) was syringed into the reaction flask, which was stirred for 5 minutes. o-Ethylbenzylamine hydrochloride (0.750 g, 4.4 mmol), as a CH₂Cl₂ suspension was then added to the reaction flask. The reaction mixture was then allowed to stir for 14 hrs at room temperature. The solvent and the excess trimethylamine and chlorodiphenylphosphine were removed in vacuo. The yellow residue was dissolved in CH₂Cl₂ and washed with 10% NaOH. The organic fraction was dried over MgSO₄ and the solvent removed after filtration, which afforded an off-white oil. After dissolving the oil in a minimum amount of CH₂Cl₂, acetonitrile was added and a white powder crashed out at room temperature to give 1.474 g of the desired compound in 67% yield. ¹H NMR (RT, 300 MHz, CDCl₃): δ=1.11 (3H, t, J_{HH}=7.6 Hz, CH₂CH₃), 2.59 (2H, q, J_{HH}=7.6 Hz, CH₂CH₃), 4.46 (2H, t, J_{HP}=9.7 Hz, NCH₂Ar), 6.66-6.75 (1H, m, NCH₂ArH), 6.87-6.97 (1H, m, NCH₂ArH), 7.05-7.12 (2H, m, NCH₂ArH), 7.19-7.45 (20H, m, ArH). ³¹P NMR (RT, 121 MHz, CDCl₃): δ=59.8 ppm (s). HRMS (Direct Insertion Probe EI) m/z calcd for C₃₃H₃₁NP₂ 503.1932. found 503.1940.

[CrCl₂((C₆H₅)₂PN(CH₂CH₂OCH₃)P(C₆H₅)₂)(μ-Cl)]₂ was prepared by the following process. In the glovebox, (C₆H₅)₂PN(CH₂CH₂OCH₃)P(C₆H₅)₂ (0.335 g, 0.7554 mmol) was dissolved in CH₂Cl₂ (3 mL). (THF)₃CrCl₃ (0.283 g, 0.7554 mmol) was dissolved in CH₂Cl₂ (7 mL) in a separate vial. The chromium starting material solution was slowly added to the stirring solution of (C₆H₅)₂PN(CH₂CH₂OCH₃)P(C₆H₅)₂. The mixture, which immediately turned blue, was allowed to react for 10 minutes after which the solvent was pumped off. The residue was triturated twice with CH₂Cl₂. The remaining solid was recrystallized from CH₂Cl₂/petroleum ether to give a bright blue/violet powder. Yield: 0.344 g (76%). Anal. calcd. for C₅₄H₅₄Cl₆Cr₂N₂O₂P₄(%): C, 53.89; H, 4.52; N, 2.33. Found: C, 53.63; H, 4.60; N, 2.26.

[CrCl₂((C₆H₅)₂PN(CH₂CH₂CH₂OCH₃)P(C₆H₅)₂)(μ-Cl)]₂ was prepared by the following process. In the glovebox, (C₆H₅)₂PN(CH₂CH₂CH₂OCH₃)P(C₆H₅)₂ (0.494 g, 1.080 mmol) was dissolved in CH₂Cl₂ (3 mL). (THF)₃CrCl₃ (0.405 g, 1.080 mmol) was dissolved in CH₂Cl₂ (7 mL) in a separate vial. The chromium starting material solution was slowly added to the stirring solution of (C₆H₅)₂PN(CH₂CH₂CH₂OCH₃)P(C₆H₅)₂. The mixture, which immediately turned blue, was allowed to react for 10 minutes after which the solvent was pumped off. The residue was triturated twice with CH₂Cl₂. The remaining solid was recrystallized from CH₂Cl₂/petroleum ether to give a blue powder. Yield: 0.599 g (90%). Anal. calcd. for C₅₆H₅₈Cl₆Cr₂N₂O₂P₄(%): C, 54.61; H, 4.75; N, 2.27. Found: C, 53.42; H, 5.08; N, 1.93.

[CrCl₂((C₆H₅)₂PN((o-OCH₃)C₆H₄)P(C₆H₅)₂)(μ-Cl)]₂ was prepared by the following process. In the glovebox, (C₆H₅)₂PN((o-OCH₃)C₆H₄)P(C₆H₅)₂ (0.364 g, 0.7406 mmol) was dissolved in CH₂Cl₂ (3 mL). (THF)₃CrCl₃ (0.278 g, 0.7406 mmol) was dissolved in CH₂Cl₂ (7 mL) in a separate vial. The chromium starting material solution was slowly added to the stirring solution of (C₆H₅)₂PN((o-OCH₃)C₆H₄)P(C₆H₅)₂. The mixture, which immediately turned blue, was allowed to react for 10 minutes after which the solvent was pumped off. The residue was triturated twice with CH₂Cl₂. The remaining solid was recrystallized from CH₂Cl₂/petroleum ether to give a dark blue powder. Yield: 0.119 g (25%). Anal. calcd. for C₆₂H₅₄Cl₆Cr₂N₂O₂P₄(%): C, 57.29; H, 4.19; N, 2.16. Found: C, 56.11; H, 4.93; N, 1.95.

[CrCl₂((C₆H₅)₂PN(CH₂(o-OCH₃)C₆H₄)P(C₆H₅)₂)(μ-Cl)]₂ was prepared by the following process. In the glovebox, (C₆H₅)₂PN(CH₂(o-OCH₃)C₆H₄)P(C₆H₅)₂ (0.547 g, 1.081 mmol) was dissolved in CH₂Cl₂ (3 mL). (THF)₃CrCl₃ (0.405 g, 1.081 mmol) was dissolved in CH₂Cl₂ (7 mL) in a separate vial. The chromium starting material solution was slowly added to the stirring solution of (C₆H₅)₂PN(CH₂(o-OCH₃)C₆H₄)P(C₆H₅)₂. The mixture, which immediately turned blue, was allowed to react for 10 minutes after which the solvent was pumped off. The residue was triturated twice with CH₂Cl₂. The remaining solid was recrystallized from CH₂Cl₂/petroleum ether to give a bright purple powder. Yield: 0.621 g (86%). Anal. calcd. for C₆₄H₅₈Cl₆Cr₂N₂O₂P₄(%): C, 57.89; H, 4.40; N, 2.11. Found: C, 57.78; H, 4.56; N, 1.98. HRMS (FAB+) m/z calcd for C₆₄H₅₈Cl₅Cr₂N₂O₂P₄ (M-Cl) 1291.0672. found 1292.0692.

[CrCl₂((C₆H₅)₂PN(CH(CH₃)₂)P(C₆H₅)₂)(μ-Cl)]₂ was prepared by the following process. In the glovebox, (C₆H₅)₂PN(CH(CH₃)₂)P(C₆H₅)₂ (0.462 g, 1.081 mmol) was dissolved in CH₂Cl₂ (3 mL). (THF)₃CrCl₃ (0.405 g, 1.081 mmol) was dissolved in CH₂Cl₂ (7 mL) in a separate vial. The chromium starting material solution was slowly added to the stirring solution of (C₆H₅)₂PN(CH(CH₃)₂)P(C₆H₅)₂. The mixture, which immediately turned blue, was allowed to react for 10 minutes after which the solvent was pumped off. The residue was triturated twice with CH₂Cl₂. The remaining solid was recrystallized from CH₂Cl₂/petroleum ether to give a purple powder. Yield: 0.530 g (84%). Anal. calcd. for C₅₄H₅₄Cl₆Cr₂N₂P₄(%): C, 55.36; H, 4.65; N, 2.39. Found: C, 53.83; H, 5.01; N, 2.26. HRMS (FAB+) m/z calcd for C₅₄H₅₄Cl₅Cr₂N₂P₄ (M-Cl) 1135.0461. found 1135.0598.

[CrCl₂((C₆H₅)₂PN(CH₂(o-CH₂CH₃)C₆H₄)P(C₆H₅)₂)(μ-Cl)]₂ was prepared by the following process. In the glovebox, (C₆H₅)₂PN(CH₂(o-CH₂CH₃)C₆H₄)P(C₆H₅)₂ (0.602 g, 1.195 mmol) was dissolved in CH₂Cl₂ (3 mL). (THF)₃CrCl₃ (0.448 g, 1.195 mmol) was dissolved in CH₂Cl₂ (7 μL) in a separate vial. The chromium starting material solution was slowly added to the stirring solution of (C₆H₅)₂PN(CH₂(o-CH₂CH₃)C₆H₄)P(C₆H₅)₂. The mixture, which immediately turned blue, was allowed to react for 10 minutes after which the solvent was pumped off. The residue was triturated twice with CH₂Cl₂. The remaining solid was recrystallized from CH₂Cl₂/petroleum ether to give a bright purple powder. Yield: 0.578 g (73%). Anal. calcd. for C₆₆H₆₂Cl₆Cr₂N₂P₄(%): C, 59.88; H, 4.72; N, 2.12. Found: C, 58.63; H, 5.03; N, 1.80. HRMS (FAB+) m /z calcd for C₆₆H₆₂Cl₅Cr₂N₂P₄ (M-Cl) 1287.1087. found 1287.0411.

### Process 1—Oligomerization of 1 atm Ethylene

In a glove box, a 25 mL round bottom flask was charged with 0.020 mmol (1 equivalent) of a first precatalyst (represented by Formula 2 in which R is CH₂(o-OCH₃)C₆H₄) in 50 mL of chlorobenzene or 1,2-dichlorobenzene to give a pale bluish-purple suspension. The flask was equipped with a 180° needle valve, and fully degassed on the vacuum line at −78° C. The system was allowed to warm up to 25° C. and was backfilled with 1 atmosphere of ethylene. With a positive pressure of ethylene, the valve was replaced with a septum and 10 wt % MAO in toluene (3.2 mL, 300 equivalents) was syringed in. The mixture immediately turned green upon addition. Ethylene consumption was monitored using a mercury manometer. After a reaction time of 90 minutes, the mixture was quenched with HCl/MeOH. An aliquot of the organic fraction was separated and filtered through a plug of activated alumina to remove any chromium. This mixture was analyzed by gas chromatography and gas-chromatography-mass spectrometry. All identified products were quantified by comparison to a mesitylene standard, which was added to the reaction mixture. The reaction mixture was then filtered and any solid was washed with HCl/MeOH and dried under vacuum for 15 hours and weighed.

### Process 2—Oligomerization of 4 atm Ethylene

In a glovebox, an 85 mL high pressure glass vessel was charged with either a first precatalyst (represented by Formula 2 in which R is CH₂(o-OCH₃)C₆H₄) or a second precatalyst (represented by Formula 2 in which R is CH₂(CH₃)₂) in 20 mL of solvent to give a pale bluish-purple suspension. The vessel was equipped with a regulator and placed on the high pressure setup. Ethylene was purged through the system after which 10 wt % MAO in toluene (1.3 mL, 300 equivalents) was added via syringe. The mixture immediately turned green upon addition. Ethylene pressure was kept constant during the reaction (i.e., 90 minutes), after which the system was vented and the reaction mixture quenched with HCl/MeOH. An aliquot of the organic fraction was separated and filtered through a plug of activated alumina to remove any chromium. This mixture was analyzed by gas chromatography and gas chromatography-mass spectrometry. All identified products were quantified by comparison to a mesitylene standard, which was added to the reaction mixture. The reaction mixture was then filtered and any solid was washed with HCl/MeOH and dried under vacuum for 15 hours and weighed.

To demonstrate the effects of different solvents, additives, co-catalysts and combinations thereof on the oligomerization reaction, these parameters were varied in the following Examples 1 through 30. In each of Examples 1 through 7 below, although the solvent was varied, the first precatalyst (0.008 mmol), 10 wt % MAO in toluene (300 equivalents), and 4 atm ethylene remained the same, and the reaction was carried out at 25° C. for 90 minutes. Similarly, in each of Examples 8 through 14, although the solvent was varied, the second precatalyst (0.008 mmol), 10 wt % MAO* in toluene (300 equivalents) and 4 atm ethylene remained the same, and the reaction was carried out at 25° C. for 90 minutes. Also, in Examples 15 through 23 below, in addition to different solvents, different additives and amounts of the additive were used, but the remaining parameters (i.e., 0.008 mmol second precatalyst, 10 wt % MAO* in toluene (300 equivalents), 4 atm ethylene, reaction temperature of 25° C. and reaction time of 90 minutes) were the same in each example. Different mixtures of solvents were used in Examples 24 and 25, but the remaining parameters (0.008 mmol first precatalyst, 10 wt % MAO in toluene (300 equivalents), 4 atm ethylene, reaction temperature of 25° C., and reaction time of 90 minutes) were the same in both examples. Finally, in Examples 26 through 30, the precatalyst, solvent and co-catalyst were varied while the remaining parameters (i.e., 4 atm ethylene, reaction temperature of 25° C., and reaction time of 90 minutes) stayed the same.

### Example 1

Oligomerization of 4 atm ethylene was conducted as in Process 2 using 0.008 mmol of the first precatalyst, 20 mL of chlorobenzene, and 10 wt % MAO in toluene (300 equivalents). The reaction was carried out at 25° C. for 90 minutes.

### Example 2

Oligomerization of 4 atm ethylene was conducted as in Example 1, except that 20 mL of toluene was used instead of chlorobenzene.

### Example 3

Oligomerization of 4 atm ethylene was conducted as in Example 1, except that 20 mL of dodecane was used instead of chlorobenzene.

### Example 4

Oligomerization of 4 atm ethylene was conducted as in Example 1, except that 20 mL of benzene was used instead of chlorobenzene.

### Example 5

Oligomerization of 4 atm ethylene was conducted as in Example 1, except that 20 mL of 1,2-dichlorobenzene was used instead of chlorobenzene.

### Example 6

Oligomerization of 4 atm ethylene was conducted as in Example 1, except that 20 mL of fluorobenzene was used instead of chlorobenzene.

### Example 7

Oligomerization of 4 atm ethylene was conducted as in Example 1, except that 1,2-difluorobenzene was used instead of chlorobenzene.

Table 1, below, shows the productivity of the reactions of each of Examples 1 through 7, the distribution of oligomers and polyethylene produced by the reactions, and the molar ratios of 1-octene/1-hexene. In Table 1, all products are reported in wt % unless otherwise designated.

TABLE 1
Comparison of Solvents in Ethylene Oligomerization using the First Precatalyst

| | | | | | | Olefins | | | |
|---|---|---|---|---|---|---|---|---|---|
| | | | | | | higher | 1-C6 | 1-C8 | Molar ratio |
| Example | Productivity | | | | | than | in C6 | in C8 | of |
| (Solvent) | (g_{product}/g_{Cr}) | PE | C6 | C8 | C10 | C10 | (%) | (%) | 1-C8/1-C6 |
| 1 | 9092 | 0.5 | 41 | 33 | 7 | 18 | 85 | 95 | 0.689 |
| (PhCl) | | | | | | | | | |
| 2 | 1203 | 20 | 28 | 49 | 1 | 1 | 64 | 99 | 1.99 |
| (toluene) | | | | | | | | | |
| 3 | <150 | >80 | <10 | <10 | <1 | <1 | NA | NA | ca. 1.00 |
| (dodecane) | | | | | | | | | |
| 4 | 1288 | 17 | 31 | 49 | 1 | 3 | 69 | 99 | 1.72 |
| (benzene) | | | | | | | | | |
| 5 | 7250 | 1 | 39 | 29 | 11 | 19 | 86 | 93 | 0.601 |
| (1,2-C₆H₄Cl₂) | | | | | | | | | |
| 6 | 10711 | 0.1 | 32 | 42 | 5 | 21 | 79 | 98 | 1.20 |
| (PhF) | | | | | | | | | |
| 7 | 7035 | 3 | 27 | 49 | 3 | 17 | 74 | 99 | 1.86 |
| (1,2-C₆H₄F₂) | | | | | | | | | |

As shown in Table 1, variation in the solvent produces very different results. For example, it can be seen that productivity and olefin distribution varies significantly depending on the solvent used in the reaction.

### Example 8

Oligomerization of 4 atm ethylene was conducted as in Process 2 using 0.008 mmol of the second precatalyst, 20 mL of chlorobenzene, and 10 wt % MAO* (aged MAO) in toluene (300 equivalents). The reaction was carried out at 25° C. for 90 minutes.

### Example 9

Oligomerization of 4 atm ethylene was conducted as in Example 8, except that 20 mL of toluene was used instead of chlorobenzene.

### Example 10

Oligomerization of 4 atm ethylene was conducted as in Example 8, except that 20 mL of dodecane was used instead of chlorobenzene.

### Example 11

Oligomerization of 4 atm ethylene was conducted as in Example 8, except that 20 mL of benzene was used instead of chlorobenzene.

### Example 12

Oligomerization of 4 atm ethylene was conducted as in Example 8, except that 20 mL of 1,2-dichlorobenzene was used instead of chlorobenzene.

### Example 13

Oligomerization of 4 atm ethylene was conducted as in Example 8, except that 20 mL of fluorobenzene was used instead of chlorobenzene.

### Example 14

Oligomerization of 4 atm ethylene was conducted as in Example 8, except that 20 mL of 1,2-difluorobenzene was used instead of chlorobenzene.

Table 2, below, shows the productivity of the reactions of each of Examples 8 through 14, the distribution of oligomers and polyethylene produced by the reactions, and the molar ratios of 1-octene/1-hexene. In Table 2, all products are reported in wt % unless otherwise designated.

TABLE 2
Comparison of Solvents in Ethylene Oligomerization using the Second Precatalyst

| | | | | | | Olefins | | | |
|---|---|---|---|---|---|---|---|---|---|
| | | | | | | higher | 1-C6 | 1-C8 | Molar ratio |
| Example | Productivity | | | | | than | in C6 | in C8 | of |
| (Solvent) | (g_{product}/g_{Cr}) | PE | C6 | C8 | C10 | C10 | (%) | (%) | 1-C8/1-C6 |
| 8 | 17616 | 0.3 | 39 | 25 | 12 | 24 | 94 | 88 | 0.439 |
| (PhCl) | | | | | | | | | |
| 9 | 1241 | 6 | 37 | 54 | 1 | 2 | 88 | 99 | 1.25 |
| (toluene) | | | | | | | | | |
| 10 | <200 | >50 | <20 | <30 | <1 | <1 | NA | NA | ca. 1.50 |
| (dodecane) | | | | | | | | | |
| 11 | 2307 | 2 | 40 | 54 | 1 | 3 | 88 | 99 | 1.14 |
| (benzene) | | | | | | | | | |
| 12 | 10204 | 0.6 | 37 | 32 | 8 | 22 | 92 | 95 | 0.668 |
| (1,2-C₆H₄Cl₂) | | | | | | | | | |
| 13 | 20270 | 0.1 | 26 | 36 | 6 | 32 | 90 | 96 | 1.10 |
| (PhF) | | | | | | | | | |
| 14 | 17980 | 0.2 | 21 | 33 | 7 | 39 | 88 | 95 | 1.24 |
| (1,2-C₆H₄F₂) | | | | | | | | | |

Table 2 also shows that variations in the solvent produce very different results. It can be seen that productivity and olefin distribution varies significantly depending on the solvent used in the reaction. In addition, comparing Table 1 to Table 2, it can be seen that modifying the co-catalyst produces drastic changes in productivity and selectivity. In particular, while Examples 1 through 7 all used MAO, Examples 8 through 14 all used MAO* (aged MAO), and the differences in productivity and selectivity between the two sets of Examples are significant. Also, the difference in precatalyst may contribute to the significant differences in productivity and selectivity reported in Tables 1 and 2. Specifically, while Examples 1 though 7 all used the first precatalyst, Examples 8 through 14 all used the second precatalyst, and the differences between the two sets of Examples are significant. Accordingly, Tables 1 and 2 show that variations in the precatalyst and the co-catalyst can produce drastic differences in the productivity and selectivity of the oligomerization reaction.

### Example 15

Oligomerization of 4 atm ethylene was conducted as in Process 2 using 0.008 mmol of the first precatalyst, 20 mL of benzene, and 10 wt % MAO* (aged MAO) in toluene (300 equivalents). In addition, 20 equivalents of C₆H₅NMe₂ was used as an additive. The reaction was carried out at 25° C. for 90 minutes.

### Example 16

Oligomerization of 4 atm ethylene was conducted as in Example 15, except that 40 equivalents of C₆H₅NMe₂ was used as an additive.

### Example 17

Oligomerization of 4 atm ethylene was conducted as in Example 15, except that 200 equivalents of C₆H₅NMe₂ was used as an additive.

### Example 18

Oligomerization of 4 atm ethylene was conducted as in Example 15, except that 20 mL of fluorobenzene was used instead of benzene.

### Example 19

Oligomerization of 4 atm ethylene was conducted as in Example 18, except that 20 equivalents of C₆H₅OMe was used as the additive instead of C₆H₅NMe₂.

### Example 20

Oligomerization of 4 atm ethylene was conducted as in Example 15, except that 20 mL of chlorobenzene was used instead of benzene.

### Example 21

Oligomerization of 4 atm ethylene was conducted as in Example 15, except that 0.008 mmol of the second precatalyst was used instead of the first precatalyst.

### Example 22

Oligomerization of 4 atm ethylene was conducted as in Example 18, except that 0.008 mmol of the second precatalyst was used instead of the first precatalyst.

### Example 23

Oligomerization of 4 atm ethylene was conducted as in Example 19, except that 0.008 mmol of the second precatalyst was used instead of the first precatalyst.

Table 3, below, shows the productivity of the reactions of each of Examples 15 through 23, the distribution of oligomers and polyethylene produced by the reactions, and the molar ratios of 1-octene/1-hexene. In Table 3, all products are reported in wt % unless otherwise designated.

TABLE 3
Comparison of Additives in Ethylene Oligomerization

| | | | | | | Olefins | | | |
|---|---|---|---|---|---|---|---|---|---|
| | | | | | | higher | 1-C6 | 1-C8 | Molar ratio |
| | Productivity | | | | | than | in C6 | in C8 | of |
| Example | (g_{product}/g_{Cr}) | PE | C6 | C8 | C10 | C10 | (%) | (%) | 1-C8/1-C6 |
| 15 | 2145 | 6 | 33 | 57 | 1 | 3 | 66 | 99 | 1.91 |
| 16 | 2010 | 7 | 31 | 58 | 1 | 3 | 62 | 99 | 2.24 |
| 17 | <200 | <10 | ca. | ca. | <1 | <1 | NA | NA | ca. 1.86 |
| | | | 36 | 55 | | | | | |
| 18 | 17857 | <0.1 | 31 | 42 | 4 | 22 | 77 | 97 | 1.32 |
| 19 | 15563 | 0.1 | 30 | 45 | 4 | 21 | 74 | 98 | 1.52 |
| 20 | 14021 | 0.2 | 37 | 36 | 6 | 21 | 81 | 97 | 0.856 |
| 21 | 1920 | 3 | 36 | 55 | 1 | 5 | 88 | 99 | 1.27 |
| 22 | 13852 | 0.1 | 29 | 43 | 4 | 24 | 89 | 98 | 1.23 |
| 23 | 10796 | 0.2 | 23 | 32 | 4 | 18 | 90 | 97 | 1.13 |

In Examples 15 through 23, the common parameters between all Examples include the use of 10 wt % MAO* in toluene (300 equivalents), the 4 atm ethylene, the reaction temperature of 25° C., and the reaction time of 90 minutes. However, the remaining parameters in these Examples varies, and certain groups of Examples can be used to compare the effects on productivity and selectivity of each of those parameters. For example, in addition to the above listed common parameters, Examples 15 through 17 also have a common solvent (benzene), precatalyst (first precatalyst), and additive composition (N,N-dimethylaniline). The variable parameter in Examples 15 through 17 is the amount of the additive, allowing a comparison of the effects on productivity and selectivity of the amount of additive. As can be seen from Table 3, the productivity and selectivity of the oligomerization reaction vary significantly depending on the amount of additive used.

Also, Examples 18 and 19 have a common precatalyst (first precatalyst), solvent (fluorobenzene), and amount of additive (20 equivalents). Similarly, Examples 22 and 23 have a common precatalyst (second precatalyst), solvent (fluorobenzene), and amount of additive (20 equivalents). The variable parameter between Examples 18 and 19 and between Examples 22 and 23 is the additive composition, allowing a comparison of the effects on productivity and selectivity of the additive composition. As shown in Table 3, the productivity and selectivity of the oligomerization reaction also varies depending on the additive composition.

Additionally, Examples 15 and 21 have a common solvent (benzene), amount of additive (20 equivalents), and additive composition (N,N-dimethylaniline). The variable parameter between these two Examples is the precatalyst composition. Similarly, Examples 18 and 22 have a common solvent (fluorobenzene), amount of additive (20 equivalents), and additive composition (N,N-dimethylaniline). The variable parameter between these two Examples is also the precatalyst composition. Also, Examples 19 and 23 have a common solvent (fluorobenzene), amount of additive (20 equivalents), and additive composition (anisole). The variable parameter between these Examples is also the precatalyst composition. As shown in Table 3, comparisons between Examples 15 and 21, between Examples 18 and 22, and between 19 and 23 reveal that the productivity and selectivity of the oligomerization reaction can vary significantly depending on the precatalyst composition used.

In addition, Examples 15, 18 and 20 have a common precatalyst (first precatalyst), amount of additive (20 equivalents), and additive composition (N,N-dimethylaniline). The variable parameter between these Examples is the solvent. As can be seen from Table 3, the productivity and selectivity of the oligomerization reaction can vary significantly depending on the solvent used.

### Example 24

Oligomerization of 4 atm ethylene was conducted as in Process 2 using 0.008 mmol of the first precatalyst, 20 mL of a 1:1 mixture of chlorobenzene and toluene, and 10 wt % MAO in toluene (300 equivalents). The reaction was carried out at 25° C. for 90 minutes.

### Example 25

Oligomerization of 4 atm ethylene was conducted as in Example 24, except that 20 mL of a 1:1 mixture of 1,2-difluorobenzene and dodecane was used instead of the chlorobenzene/toluene mixture.

Table 4, below, shows the productivity of the reactions of each of Examples 24 and 25, the distribution of oligomers and polyethylene produced by the reactions, and the molar ratios of 1-octene/1-hexene. In Table 4, all products are reported in wt % unless otherwise designated.

TABLE 4
Comparison of Solvent Mixtures in Ethylene Oligomerization

| | | | | | | Olefins | | | |
|---|---|---|---|---|---|---|---|---|---|
| | | | | | | higher | 1-C6 | 1-C8 | |
| | Productivity | | | | | than | in C6 | in C8 | Molar ratio of |
| Example | (g_{product}/g_{Cr}) | PE | C6 | C8 | C10 | C10 | (%) | (%) | 1-C8/1-C6 |
| 24 | 5698 | 1 | 37 | 50 | 2 | 9 | 75 | 99 | 1.34 |
| 25 | 10578 | 0.5 | 27 | 47 | 3 | 21 | 73 | 98 | 1.75 |

As shown in Table 4, the solvent including a 1:1 mixture of chlorobenzene and toluene (Example 24) resulted in intermediate productivity, but an increased ratio of 1-octene/1-hexene as compared to chlorobenzene or toluene alone (Examples 1 and 2, respectively), as shown in Table 1 (reporting productivity and selectivity data for Examples 1 through having the same parameters as Examples 24 and 25 reported in Table 4 except for the solvent). Also, the solvent including a 1:1 mixture of 1,2-difluorobenzene and dodecane (Example 25) resulted in increased overall activity and decreased amounts of polyethylene over either 1,2-difluorobenzene or dodecane alone (Examples 7 and 3, respectively), as shown in Table 2.

### Example 26

Oligomerization of 4 atm ethylene was conducted as in Process 2 using 0.008 mmol of the first precatalyst, 20 mL of chlorobenzene, and 10 wt % MAO* (aged MAO) in toluene (300 equivalents). The reaction was carried out at 25° C. for 90 minutes.

### Example 27

Oligomerization of 4 atm ethylene was conducted as in Example 26, except that 20 mL of fluorobenzene was used instead of chlorobenzene.

### Example 28

Oligomerization of 4 atm ethylene was conducted as in Example 26, except that 10 wt % F-MAO in toluene was used instead of MAO*.

### Example 29

Oligomerization of 4 atm ethylene was conducted as in Example 28, except that 20 mL of fluorobenzene was used instead of chlorobenzene.

### Example 30

Oligomerization of 4 atm ethylene was conducted as in Example 28, except that 0.008 mmol of the second precatalyst was used instead of the first precatalyst.

Table 5, below, shows the productivity of the reactions of each of Examples 26 through 30, the distribution of oligomers and polyethylene produced by the reactions, and the molar ratios of 1-octene/1-hexene. In Table 5, all products are reported in wt % unless otherwise designated.

TABLE 5
Comparison of Co-catalysts in Ethylene Oligomerization

| | | | | | | Olefins | | | |
|---|---|---|---|---|---|---|---|---|---|
| | | | | | | higher | 1-C6 | 1-C8 | |
| | Productivity | | | | | than | in C6 | in C8 | Molar ratio of |
| Example | (g_{product}/g_{Cr}) | PE | C6 | C8 | C10 | C10 | (%) | (%) | 1-C8/1-C6 |
| 26 | 17062 | 0.2 | 38 | 31 | 7 | 23 | 82 | 95 | 0.718 |
| 27 | 15904 | 0.2 | 30 | 42 | 4 | 24 | 73 | 97 | 1.39 |
| 28 | 13103 | 1 | 37 | 28 | 10 | 23 | 85 | 92 | 0.622 |
| 29 | 12670 | 0.6 | 30 | 43 | 4 | 23 | 74 | 98 | 1.43 |
| 30 | 20349 | 0.4 | 34 | 21 | 14 | 30 | 94 | 84 | 0.410 |

As shown in Table 5, addition of an aluminoxane co-catalyst (here either MAO* or F-MAO) increases productivity by about 20 to about 50% compared with MAO alone in a solvent (as reported in Table 1). While the selectivity between oligomers is also affected by the difference in co-catalyst, the difference is not nearly as great as the difference in productivity.

While the present invention has been illustrated and described with reference to certain exemplary embodiments, those of ordinary skill in the art will understand that various modifications and changes may be made to the described embodiments without departing from the spirit and scope of the present invention, as defined in the following claims.

What is claimed is:

1. A catalyst system for oligomerization of ethylene, the system comprising: ethylene;
a catalyst;
a co-catalyst; and
a mixture of at least two solvents.

2. The catalyst system according to claim 1, wherein the system further comprises a coordinating additive.

3. The catalyst system according to claim 2, wherein the coordinating additive is selected from anisole and N,N-dimethylaniline.

4. The catalyst system according to claim 1, wherein the co-catalyst is selected from methylaluminoxane, partially halogenated methylaluminoxane, and aged methylaluminoxane.

5. The catalyst system according to claim 1, wherein the catalyst is a chromium based precatalyst and is activated with the co-catalyst.

6. The catalyst system according to claim 1, wherein the mixture of at least two solvents comprises a mixture of polar and nonpolar solvents.

7. A catalyst system for oligomerization of ethylene, the system comprising:
ethylene;
a catalyst;
a co-catalyst selected from partially halogenated methylaluminoxane and aged methylaluminoxane; and
at least one solvent.

8. The catalyst system according to claim 7, wherein the system further comprises a coordinating additive.

9. The catalyst system according to claim 8, wherein the coordinating additive is selected from anisole and N,N-dimethylaniline.

10. The catalyst system according to claim 7, wherein the at least one solvent comprises a mixture of at least two solvents.

11. The catalyst system according to claim 10, wherein the mixture of at least two solvents comprises a mixture of polar and nonpolar solvents.

12. The catalyst system according to claim 7, wherein the catalyst is a chromium based precatalyst and is activated with the co-catalyst.

13. A catalyst system for oligomerization of ethylene, the system comprising:
ethylene;
a catalyst;
a co-catalyst;
at least one solvent; and
a coordinating additive.

14. The catalyst system according to claim 13, wherein the coordinating additive is selected from anisole and N,N-dimethylaniline.

15. The catalyst system according to claim 13, wherein the at least one solvent comprises a mixture of at least two solvents.

16. The catalyst system according to claim 15, wherein the mixture of at least two solvents comprises a mixture of polar and nonpolar solvents.
